(19) United States
(12) Patent Application Publication
(10) Pub. No.: US 2022/0027779 A1
(43) Pub. Date: Jan. 27, 2022

(54) VALUE OVER REPLACEMENT FEATURE (VORF) BASED DETERMINATION OF FEATURE IMPORTANCE IN MACHINE LEARNING

(71) Applicant: Intuit Inc., Mountain View, CA (US)

(72) Inventors: Yehezkel Shraga Resheff, Tel Aviv (IL); Talia Tron, Shefayim (IL); Tzvi Itzhak Barnholtz, Raanana (IL)

(73) Assignee: Intuit Inc., Mountain View, CA (US)

(21) Appl. No.: 16/936,057

(22) Filed: Jul. 22, 2020

(51) Int. Cl. G06N 20/00; G06K 9/62

(52) U.S. Cl. CPC G06N 20/00; G06K 9/6256; G06K 9/6229; G06K 9/623

(57) ABSTRACT

Systems and models are disclosed for determining a value over replacement feature (VORF) for one or more features of a machine learning model. An example method includes selecting one or more features used in the machine learning model, determining a comparison set of unused features not used in the machine learning model, for each unused feature in the comparison set, determining a difference in a specified metric when the selected one or more features are replaced by a corresponding unused feature from the comparison set, and determining the VORF to be the smallest difference in the specified metric.

### TECHNICAL FIELD

This disclosure relates generally to selection of features for machine learning, and more particularly to efficient and explainable feature selection.

### DESCRIPTION OF RELATED ART

Feature selection is an important part of constructing models for machine learning applications. Selection of appropriate features may help to improve training times, reduce complexity of resulting models, avoid inclusion of features which may be redundant or irrelevant, and so on. Further, feature selection may simplify model analysis, making predictions by trained models easier to understand and interpret by researchers and users. In explainable artificial intelligence (AI) (also called “XAI”) applications, methods and techniques are used for AI technology such that resulting solutions, models, and so on may be understood by human experts. As such, determining why some features are selected or not selected, and which features are most important to prediction accuracy, may be particularly helpful in XAI contexts.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for determining a value over replacement feature (VORF) for one or more features of a machine learning model. An example method may include selecting one or more features used in the machine learning model, determining a comparison set of unused features not used in the machine learning model, for each unused feature in the comparison set, determining a difference in a specified metric when the selected one or more features are replaced by a corresponding unused feature from the comparison set, and determining the VORF to be the smallest difference in the specified metric.

In some aspects, the specified metric may be an accuracy metric, or a metric of accuracy per unit cost. The comparison set may include a subset of features available for use but not currently used by the machine learning model. The subset may be a randomly selected subset of the features available for use but not currently used by the machine learning model.

In some aspects, determining the difference in the specified metric includes, for each unused feature in the comparison set, determining a first value of the specified metric for the machine learning model including the selected one or more features, retraining the machine learning model with the selected one or more features replaced by a corresponding unused feature in the comparison set, determining a second value of the specified metric for the retrained machine learning model, and determining the difference in the specified metric to be a difference between the first value of the specified metric and the second value of the specified metric.

In some aspects, the method may further include determining a VORF for each used feature of a plurality of used feature of the machine learning model and determining a most valuable feature of the plurality of used features to be the used feature having the largest VORF. In some aspects, determining the VORF for each used feature of the plurality of used feature includes normalizing each determined VORF based at least in part on the VORF of the most valuable feature.

Another innovative aspect of the subject matter described in this disclosure can be implemented as an apparatus coupled to a machine learning model. An example apparatus may include one or more processors and a memory storing instructions for execution by the one or more processors. Execution of the instructions causes the apparatus to perform operations including selecting one or more features used in the machine learning model, determining a comparison set of unused features not used in the machine learning model, for each unused feature in the comparison set, determining a difference in a specified metric when the selected one or more features are replaced by a corresponding unused feature from the comparison set, and determining a value over replacement feature (VORF) of the selected one or more features to be the smallest difference in the specified metric.

In some aspects, the specified metric may be an accuracy metric, or a metric of accuracy per unit cost. The comparison set may include a subset of features available for use but not currently used by the machine learning model. The subset may be a randomly selected subset of the features available for use but not currently used by the machine learning model.

In some aspects, determining the difference in the specified metric includes, for each unused feature in the comparison set, determining a first value of the specified metric for the machine learning model including the selected one or more features, retraining the machine learning model with the selected one or more features replaced by a corresponding unused feature in the comparison set, determining a second value of the specified metric for the retrained machine learning model, and determining the difference in the specified metric to be a difference between the first value of the specified metric and the second value of the specified metric.

In some aspects, the method may further include determining a VORF for each used feature of a plurality of used feature of the machine learning model and determining a most valuable feature of the plurality of used features to be the used feature having the largest VORF. In some aspects, determining the VORF for each used feature of the plurality of used feature includes normalizing each determined VORF based at least in part on the VORF of the most valuable feature.

Another innovative aspect of the subject matter described in this disclosure can be implemented as a non-transitory computer-readable storage medium storing instructions for execution by one or more processors of an apparatus coupled to a machine learning model. Execution of the instructions causes the apparatus to perform operations including selecting one or more features used in the machine learning model, determining a comparison set of unused features not used in the machine learning model, for each unused feature in the comparison set, determining a difference in a specified metric when the selected one or more features are replaced by a corresponding unused feature from the comparison set, and determining a value over replacement feature (VORF) of the selected one or more features to be the smallest difference in the specified metric.

In some aspects, the specified metric may be an accuracy metric, or a metric of accuracy per unit cost. The comparison set may include a subset of features available for use but not currently used by the machine learning model. The subset may be a randomly selected subset of the features available for use but not currently used by the machine learning model.

In some aspects, determining the difference in the specified metric includes, for each unused feature in the comparison set, determining a first value of the specified metric for the machine learning model including the selected one or more features, retraining the machine learning model with the selected one or more features replaced by a corresponding unused feature in the comparison set, determining a second value of the specified metric for the retrained machine learning model, and determining the difference in the specified metric to be a difference between the first value of the specified metric and the second value of the specified metric.

In some aspects, the method may further include determining a VORF for each used feature of a plurality of used feature of the machine learning model and determining a most valuable feature of the plurality of used features to be the used feature having the largest VORF. In some aspects, determining the VORF for each used feature of the plurality of used feature includes normalizing each determined VORF based at least in part on the VORF of the most valuable feature.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The example implementations are illustrated by way of example and are not intended to be limited by the figures of the accompanying drawings. Like numbers reference like elements throughout the drawings and specification. Note that the relative dimensions of the following figures may not be drawn to scale.

FIG. 1 shows a feature value determination system, according to some implementations.

FIG. 2 shows a high-level overview of an example process flow that can be employed by the feature value determination system of FIG. 1.

FIG. 3 shows an illustrative flow chart depicting an example operation for determining a value over replacement feature (VORF) for one or more features of a machine learning model, according to some implementations.

FIG. 4 shows an illustrative flow chart depicting an example operation for determining a difference in a specified metric, according to some implementations.

FIG. 5 shows an illustrative flow chart depicting an example operation for determining a most valuable feature used by a machine learning model, according to some implementations.

### DETAILED DESCRIPTION

Implementations of the subject matter described in this disclosure can be used for assessing the value of included features in a machine learning model as compared to available but unused features. This is in contrast to conventional measurements of feature value, which determine feature value only based on used features. For example, a conventional measurement of feature value may determine a difference in the machine learning model's performance when a feature is used as compared to when the feature is unused. In accordance with various aspects of the present disclosure, the value of one or more used features as compared to available but unused features may be determined as a value over replacement feature or “VORF.” A VORF may indicate a difference in a relevant metric when replacing the one or more used features with a next best option from the set of available but unused features. For example, the relevant metric may be a model accuracy metric, and the VORF may thus indicate an amount of increased model accuracy provided by the one or more used features as compared to other available but unused features. In some other implementations the relevant metric may be based on a combination of accuracy and computational complexity, such as a metric of accuracy per unit of time/computational resources. Assessing the value of used features in this may aid in understanding which features are the most important for accurate prediction, which may be of particular importance in explainable artificial intelligence (XAI) applications, where explainability and understandability of machine learning models by human experts is important. For example, determining a VORF for each used feature in a machine learning model may indicate the features which are most important for model accuracy. Further, determining the value of included features may aid in model efficiency, such as aiding in determining when an included feature may be replaced with a less computationally complex alternative without greatly affecting model accuracy.

Various implementations of the subject matter disclosed herein provide one or more technical solutions to the technical problem of explainably determining feature value in a machine learning model relative to available but unused features. More specifically, various aspects of the present disclosure provide a unique computing solution to a unique computing problem that did not exist prior to the development of machine learning algorithms or XAI techniques. Further, by determining used feature value relative to available but unused features, implementations of the subject matter disclosed herein provide meaningful improvements to the performance and effectiveness of machine learning models by allowing for more accurate and explainable determination of the relative value of used features. As such, implementations of the subject matter disclosed herein are not an abstract idea such as organizing human activity or a mental process that can be performed in the human mind, for example, because the human mind is not capable of training machine learning models and determining a first value of a relevant metric, much less retraining the machine learning model with one or more features replaced by available but unused features and determining a second value of the relevant metric for determining a difference between the first and the second values.

Moreover, various aspects of the present disclosure effect an improvement in the technical field of explainably determining feature value in a machine learning model relative to available but unused features. Whereas conventional techniques for determining feature value consider only used features, aspects of the present disclosure also consider available but unused features, allowing for a broader understanding of the true feature value. The described methods for determining value over replacement features (VORFs) cannot be performed in the human mind, much less using pen and paper. For example, determining a first accuracy metric or another suitable metric for a trained machine learning model cannot be performed in the human mind, much less replacing one or more features of the machine learning model with previously unused features, retraining the machine learning model, and determining a second accuracy metric for the retrained machine learning model. In addition, implementations of the subject matter disclosed herein do far more than merely create contractual relationships, hedge risks, mitigate settlement risks, and the like, and therefore cannot be considered a fundamental economic practice.

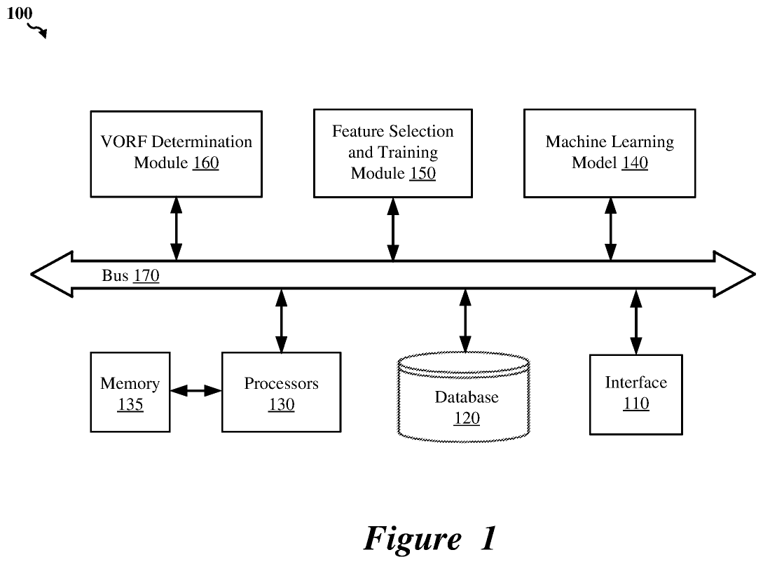

FIG. 1 shows a feature value determination system 100, according to some implementations. Various aspects of the feature value determination system 100 disclosed herein are applicable for determining values of features included in a machine learning model relative to features available but not included in the machine learning model. For example, the feature value determination system 100 can determine a value over replacement feature (VORF) for one or more features included in the machine learning model. Features currently included in the machine learning model may be referred to as “used” by the machine learning model. Similarly, available but not currently included features may be referred to as “unused” features of the machine learning model. In some implementations, determining a VORF for one or more used features may include determining a first value of a relevant metric for the machine learning model with the one or more features included. Such a metric may be a model accuracy metric, a metric of computational complexity, or any other suitable metric for model performance. The machine learning model may then be sequentially retrained using each feature of a set of available but unused features replacing the one or more used features, and corresponding values of the relevant metric again determined for each feature of the set. The VORF may then be determined based on the respective differences between the first value of the metric and the corresponding values of the metric for the set of available but unused features. For example, the VORF may be determined to be the difference between the first value of the metric and the value corresponding to the best performing of the set of available but unused features.

The feature value determination system 100 is shown to include an input/output (I/O) interface 110, a database 120, one or more data processors 130, a memory 135 coupled to the one or more data processors 130, a machine learning model 140, a feature selection and training module 150, and VORF determination module 160. In some implementations, the various components of the feature value determination system 100 can be interconnected by at least a data bus 170, as depicted in the example of FIG. 1. In other implementations, the various components of the feature value determination system 100 can be interconnected using other suitable signal routing resources.

The interface 110 can include a screen, an input device, and other suitable elements that allow a user to provide information to the feature value determination system 100 and/or to retrieve information from the feature value determination system 100. Example information that can be provided to the feature value determination system 100 can include one or more sources of training data, one or more model training functions, and so on. Example information that can be retrieved from the feature value determination system 100 can include one or more values of used features, such as one of more VORFs for used features, one or more costs of used features, such as computational costs, and so on.

The database 120, which represents any suitable number of databases, can store any suitable information pertaining to sources of training data, training functions, sets of used features, sets of unused features, and so on for the feature value determination system 100. The sources of training data can include one or more sets of data for training purposes, one or more sets of data for validation purposes, one or more sets of data for testing purposes, and so on. The one or more sets of data for training purposes (“training data”) may be used for machine learning model training. In some aspects, during training, the partially trained machine learning model may be used for predicting values in the one or more sets of data for validation purposes, e.g., to provide an evaluation of the model fit on the training data set. In some aspects the one or more sets of data for testing purposes may be used to provide an evaluation of the trained machine learning model, for example based on one or more relevant metrics. In some implementations, the database 120 can be a relational database capable of presenting the information as data sets to a user in tabular form and capable of manipulating the data sets using relational operators. In some aspects, the database 120 can use Structured Query Language (SQL) for querying and maintaining the database 120.

The data processors 130, which can be used for general data processing operations, can be one or more suitable processors capable of executing scripts or instructions of one or more software programs stored in the feature value determination system 100 (such as within the memory 135). The data processors 130 can be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 can be implemented as a combination of computing devices (such as a combination of a DSP and a microprocessor, a plurality of microprocessors, one or more microprocessors in conjunction with a DSP core, or any other such configuration). In some implementations, the data processors 130 can be remotely located from one or more other components of feature value determination system 100.

The memory 135, which can be any suitable persistent memory (such as non-volatile memory or non-transitory memory) can store any number of software programs, executable instructions, machine code, algorithms, and the like that can be executed by the data processors 130 to perform one or more corresponding operations or functions. In some implementations, hardwired circuitry can be used in place of, or in combination with, software instructions to implement aspects of the disclosure. As such, implementations of the subject matter disclosed herein are not limited to any specific combination of hardware circuitry and/or software.

The machine learning model 140 may store any number of machine learning models that can be used to forecast values for one or more data streams. A machine learning model can take the form of an extensible data structure that can be used to represent sets of words or phrases and/or can be used to represent sets of attributes or features. The machine learning models may be seeded with historical data indicating historical data stream values. In some implementations, the machine learning model 140 may include one or more deep neural networks (DNN), which may have any suitable architecture, such as a feedforward architecture or a recurrent architecture. The machine learning model 140 may implement one or more algorithms, such as one or more classification algorithms, one or more regression algorithms, and the like. As discussed further below, the machine learning model may be configured to include a plurality of used features, selected as a subset from a set of available features.

While the machine learning model 140 is shown in FIG. 1 as being included in the feature value determination system 100, in some implementations the machine learning model 140 may instead be separate from and coupled to the feature value determination system 100.

The feature selection and training module 150 can select, from the set of available features, a plurality of features for inclusion in the machine learning model 140. The machine learning model 140 is trained based on one or more model training functions and using data from one or more sources of training data stored in the database 120 for forecasting values of the one or more data streams. Further, the feature selection and training module 150 can replace one or more included features with one or more unused features from the set of available features and retrain the machine learning model 140 using the same model training functions and the same sources of training data. Features refer to individual measurable properties or characteristics which may be used by a machine learning model for making inferences about data. Features may often be numeric but may also relate to strings or graphs depending on the context. Features may vary depending on the type of data being predicted by the machine learning model. For example, if the machine learning model 140 relates to character recognition, features may include histograms counting a number of black pixels along horizontal and vertical directions, number of internal holes, number of strokes detected, and so on. In contrast, if machine learning model 140 relates to spam detection, features may include, for example, presence or absence of specified email headers, email structure, language used, frequency of specified terms, aspects relating to grammatical correctness of the text, and so on. A feature may be “used” when it is used by the machine learning model 140 when the feature is used for training the machine learning model 140, and for subsequently making predictions using the trained machine learning model 140. A feature is unused but available when it is not currently used, but the machine learning model 140 is capable of being retrained using the unused feature. For example, data relating to the unused feature may be stored in the database 120, and the feature selection and training model 150 can use the data relating to the unused feature for retraining the machine learning model 140. Thus, in one example relating to character recognition, the machine learning model 140 may have initially not be trained using a feature relating to the number of strokes detected in a document, but the feature selection and training model 150 may retrain the machine learning model 140 based on this previously unused feature.

The value over replacement feature (VORF) determination module 160 determines a VORF for one or more included features of the machine learning model 140. For example, determining the VORF for one or more included features may include determining a first value of a relevant metric for the machine learning model 140 with the one or more included features. As mentioned above, the relevant metric may be a model accuracy metric, a metric based on accuracy and computational complexity, or another suitable metric for measuring performance of the machine learning model 140. An example model accuracy metric may be an overall prediction accuracy of the trained machine learning model when predicting values of a specified data set, such as a. An example metric based on accuracy and computational complexity may be a prediction accuracy normalized by cost, such as a prediction accuracy per unit training time, a prediction accuracy after a specified amount of training time, and so on. The one or more include features may then be sequentially replaced by each unused feature in a set of available but unused features, and the machine learning model 140 may be retrained using feature selection and training module 150. As discussed further below, the set of available but unused features may include every unused feature, may include a randomly selected set of unused features, may include a subset of unused features capable of similar functionality as the one or more used features, and so on. For each unused feature in the set of available but unused features, after the machine learning model 140 is retrained, a corresponding value of the relevant metric may be determined, and a difference between the first value and the corresponding value calculated. The VORF may then be determined to be the difference between the first value and the value of the relevant metric for the best-performing of the features in the set of available but unused features. For example, if the metric is a model accuracy metric, where greater accuracy corresponding to better performance, then the VORF may be selected to be the unused feature having the smallest difference between the first value and the corresponding value. As further discussed below, the VORF determination module 160 may also determine a VORF for each used feature of a plurality of used features and then determine a most valuable feature of the plurality of used features to be the used feature having the largest VORF.

The particular architecture of the feature value determination system 100 shown in FIG. 1 is but one example of a variety of different architectures within which aspects of the present disclosure can be implemented. For example, in other implementations, the feature value determination system 100 may not include a machine learning model 140, the functions of which can be implemented by the processors 130 executing corresponding instructions or scripts stored in the memory 135. In some other implementations, the functions of the feature selection and training module 150 can be performed by the processors 130 executing corresponding instructions or scripts stored in the memory 135. Similarly, the functions of the VORF determination module 160 can be performed by the processors 130 executing corresponding instructions or scripts stored in the memory 135. In some other examples, the feature value determination system 100 can be implemented as software as a service (SaaS), or as managed software as a service (MSaaS). For example, when implemented as SaaS or MSaaS the functions of the feature value determination system 100 can be centrally hosted and can be accessed by users using a thin client, such as a web browser.

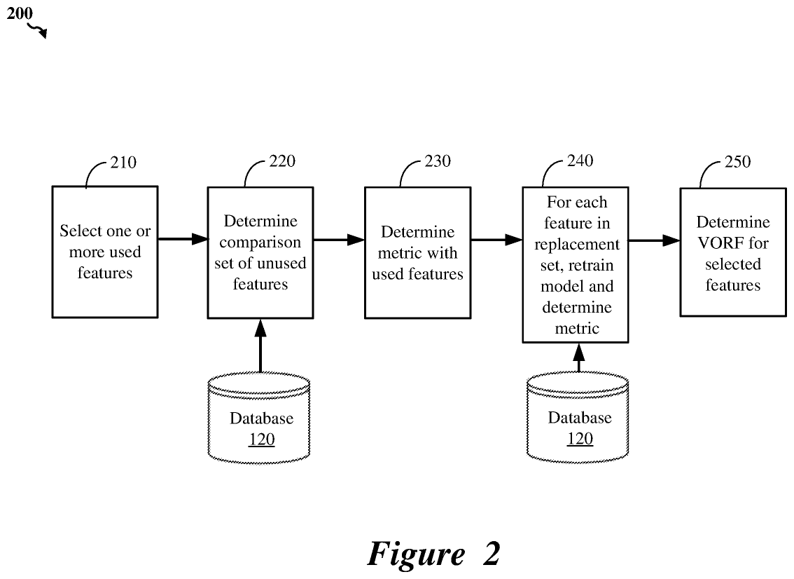

FIG. 2 shows a high-level overview of an example process flow 200 that can be employed by the feature value determination system 100 of FIG. 1. While not shown in FIG. 2 for simplicity, prior to the steps in process flow 200, the machine learning model 140 may be trained using a set of used features. For example, the machine learning model 140 may be trained based on a specified model training function, including a selected set of features, and not including an unselected set of available features. In some implementations, the machine learning model 140 may be trained using one or more sets of training data, such as one or more training data sets and one or more validation data sets. At block 210, one or more used features of the trained machine learning model 140 may be selected for VORF determination. For example, the one or more used features may be selected using feature selection and training module 150 for example from the database 120 or from another suitable local source. In some aspects the currently used features may be indicated in a suitable data structure, such as a list, chart, or so on stored in the database 120 or the other local source. At block 220, a comparison set of unused features is determined. For example, the comparison set may be determined using feature selection and training model 150. In some aspects, the comparison set may be determined based on data retrieved from the database 120, such as a list, chart, table, or other suitable data structure stored in the database 120. As discussed further below, the comparison set may be a set of available unused features to which the selected one or more used features are to be compared in order to determine the VORF of the one or more used features. In some implementations, the comparison set may include every unused feature available to the machine learning model 140, while in some other implementations the comparison set may include only a subset of the unused features available to the machine learning model 140. At block 230, a first value of a relevant metric is determined for the machine learning model 140 which has been trained including the selected one or more used features. The relevant metric may be a metric suitable for measuring the performance of the machine learning model 140, such as a measure of accuracy, computational complexity, and so on. In some aspects, the first value of the relevant metric may be determined based on one or more data sets retrieved from the database 120, such as one or more test data sets. The first value of the relevant metric may, in some implementations, be determined using the VORF determination module 160. At block 240, the machine learning model 140 may be retrained for each feature in the comparison set. For each feature in the comparison set, the selected one or more used features may be replaced by a feature from the comparison set, and the machine learning model 140 may be retrained. For each retraining, the machine learning model 140 may be retrained using the same model training function and training data as used for initially training the machine learning model 140. After each retraining, a corresponding value of the relevant metric is determined. In some aspects, the corresponding values of the relevant metric are each determined based on the same one or more data sets as used for determining the first value of the relevant metric. The machine learning model may be retrained using feature selection and training module 150, for example using a set of training data stored in the database 120. The corresponding values of the relevant metric may be determined using VORF determination module 160. At block 250, a VORF is determined for the selected one or more used features of the machine learning model 140, for example using VORF determination module 160. As discussed further below, the VORF may be determined based on respective differences between the first value of the relevant metric and respective values of the relevant metric corresponding to each feature of the comparison set. The VORF for the selected one or more used features may be determined as the difference between the first value and the value of the relevant metric for the best-performing feature of the comparison set. For example, if the metric is an estimated accuracy, the VORF may be selected as the difference between the estimated accuracy for the selected or more used features and the highest accuracy determined for the features of the comparison set. Thus, the VORF indicates how much better the selected one or more used features are, as measured by the relevant metric, than the available unused alternative features in the comparison set.

As discussed above, assessing the value, or importance, of features in a machine learning model may be valuable in a number of contexts, such as XAI, where human understandability of machine learning or AI systems is particularly important. Conventional techniques for determining feature value are based on the selected set of used features, and do not account for performance relative to available but unused features. Example implementations improve determinations of feature value by allowing for incorporation of available but unused features into assessments of feature value. Thus, feature value is measured using a value over replacement feature (VORF). Such VORF measurements may enhance the understanding of which features in a machine learning model are the most valuable by assessing feature value relative to available alternative features. For example, a given used feature may have a high value relative to other used features, but if a simpler alternative feature is available and as valuable or nearly as valuable, this may substantially reduce the desirability or real value of the given used feature. In other words, a feature which may be replaced without significantly affecting model performance is not a vitally important feature. Further, determining a VORF for each used feature, or for a plurality of used features, may provide a more accurate and significantly more human understandable assessment of feature value relative to available alternatives, for example allowing for the identification of those features which are most important to model performance, given the available alternatives.

In some aspects, the VORF may be based on a set of differences {Di}={V1−Vi}, where V1 is the first value of the relevant metric, Di is the difference corresponding to the ith feature in the comparison set, and Vi are the corresponding values of the relevant metric for the ith feature in the comparison set, for i ranging between 1 and the number N of features in the comparison set. For example, if higher values of the relevant metric reflect better performance, as when the relevant metric is a metric of model accuracy, then the VORF may be the smallest Di in the set.

In one simplified example, consider a used feature a, and a comparison set including 3 unused but available features b, c, and d. The relevant metric may be an estimated percentage accuracy of the machine learning model, trained using a common set of training data, where the metric is determined based on a common set of validation or testing data. The value of the metric for used feature a, that is, V1 above, may be 90%. Feature a may be replaced with each of features b, c, and d, and the machine learning model retrained using the same training data. After each retraining, a value of the metric may be determined using the set of validation data or testing data. These values, Vb, Vc, and Vd, may be determined to be 85%, 80%, and 88%, respectively. Thus feature d is the best performing of the comparison set. The VORF is therefore determined to be 90%−88%=2%, representing the value of feature a over the best available alternative feature d.

As discussed above, the machine learning model is retrained for determination of the metric for each feature in the comparison set. Consequently, selection of the comparison set may have a significant impact in the computational resources required for determining a VORF. In some implementations, the comparison set may include each available but unused feature. Determining a VORF using such a comparison set may be called determining a value over best replacement feature or “best VORF.” Determining a best VORF may provide the most accurate determination of a feature's value relative to available alternatives but may also have a high computational cost. As an alternative, a subset of available but unused features may be selected as the comparison set, such as a randomly or pseudorandomly determined subset of. Determining a VORF using a randomly or pseudorandomly determined subset of the available unused features may be called determining a value over random replacement feature, or “random VORF.” In some aspects, a random comparison set may be determined in advance of determining any VORFs, for example the random comparison set may be determined when initially training the machine learning model. In some other aspects, the random comparison set may be determined at the time of calculating a VORF. For example, determining the VORF may include first determining the random comparison set. In some aspects the size of the random comparison set may be selected based on a desired amount of time or computational resources available for determining the VORF. For example, the size of the random comparison set may be based on the desired amount of time or computational resources available, such that smaller comparison sets are used when lesser amounts of time or computational resources are available.

When determining VORFs for all used features, or for a plurality of used features, it may be desirable to normalize the determined VORFs to aid comparison of the VORFs of different features. Thus, when a plurality of VORFs are determined, the largest VORF may be normalized to a desired constant value, such as “1” or “100%,” while other features have VORFs which may be expressed relative to the largest VORF, such as being expressed as a proportion or percentage of the largest VORF. In one example, if the largest VORF is 0.05 and VORFs of other features are 0.04 and 0.03, with the largest VORF normalized to 1 or 100%, the other VORFs may be respectively normalized to 0.8 or 80% and 0.6 or 60%. Such normalization may allow for straightforward comparison of the values of the used features.

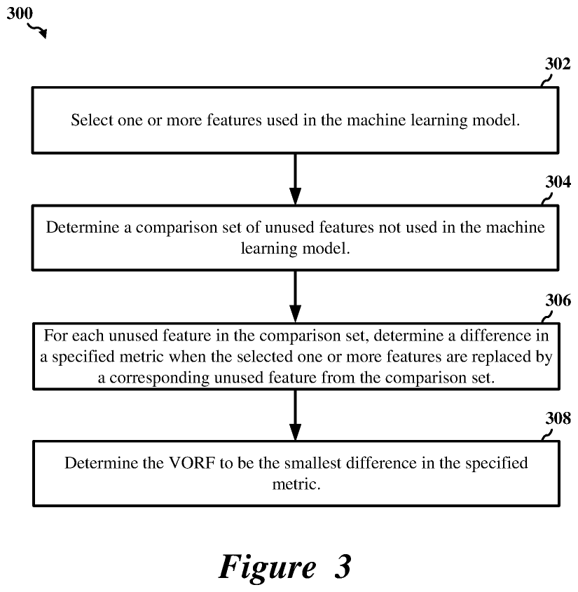

FIG. 3 shows an illustrative flow chart depicting an example operation 300 for determining a value over replacement feature (VORF) for one or more features of a machine learning model, according to some implementations. The example operation 300 can be performed by one or more processors of a system. For example, the system can include or can be associated with the feature value determination system 100 of FIG. 1. It is to be understood that the example operation 300 can be performed by any suitable systems, computers, or servers.

At block 302, the feature value determination system 100 selects one or more features used in the machine learning model. At block 304, the feature value determination system 100 determines a comparison set of unused features not used in the machine learning model. At block 306, the feature value determination system 100 determines, for each unused feature in the comparison set, a difference in a specified metric when the selected one or more features are replaced by a corresponding unused feature from the comparison set. At block 308, the feature value determination system 100 determines the VORF to be the smallest difference in the specified metric.

In some aspects, the specified metric is an accuracy metric. In some other aspects, the specified metric is an accuracy per unit computational complexity metric. In some aspects, the comparison set is a set of all features available for use but not currently used by the machine learning model. In some other aspects, the comparison set is a subset of features available for use but not currently used by the machine learning model. The subset may be a randomly determined subset.

In some aspects, determining the difference in the specified metric, in block 306, includes determining a first value of the specified metric for the machine learning model including the selected one or more features, retraining the machine learning model with the selected one or more features replaced by a corresponding feature in the comparison set, determining a second value of the specified metric for the retrained machine learning model, and determining the difference in the specified metric to be a difference between the first value of the specified metric and the second value of the specified metric.

In some implementations the operation 300 may further include determining a VORF for each used feature of a plurality of used features of the machine learning model and determining a most valuable feature of the plurality of used features to be the used feature having the largest VORF. In some aspects, determining the VORF for each feature of the plurality of used features includes normalizing each determined VORF based at least in part on the VORF of the most valuable feature.

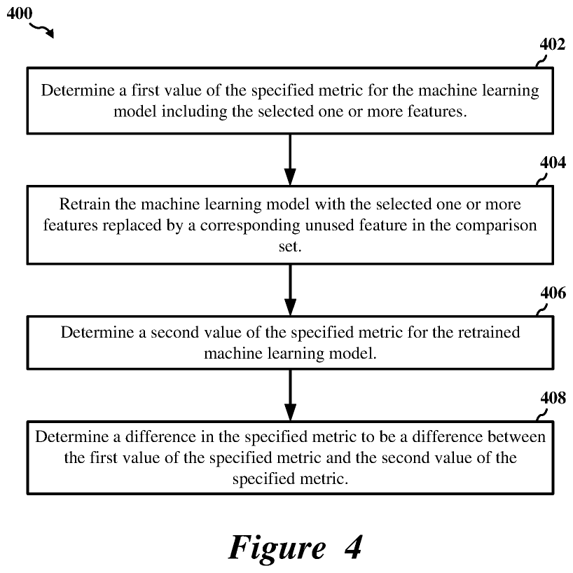

FIG. 4 shows an illustrative flow chart depicting an example operation 400 for determining a difference in a specified metric, according to some implementations. The example operation 400 can be performed by one or more processors of a system. For example, the system can include or can be associated with the feature value determination system 100 of FIG. 1. It is to be understood that the example operation 400 can be performed by any suitable systems, computers, or servers. In some implementations, the operation 400 can be performed for each unused feature in the comparison set in block 306 of the operation 300 of FIG. 3.

At block 402, the feature value determination system 100 determines a first value of the specified metric for the machine learning model trained including the selected one or more features. At block 404, the feature value determination system 100 retrains the machine learning model with the selected one or more features replaced by a corresponding unused feature in the comparison set. At block 406, the feature value determination system 100 determines a second value of the specified metric for the retrained machine learning model. At block 408, the feature value determination system 100 determines a difference in the specified metric to be a difference between the first value of the specified metric and the second value of the specified metric.

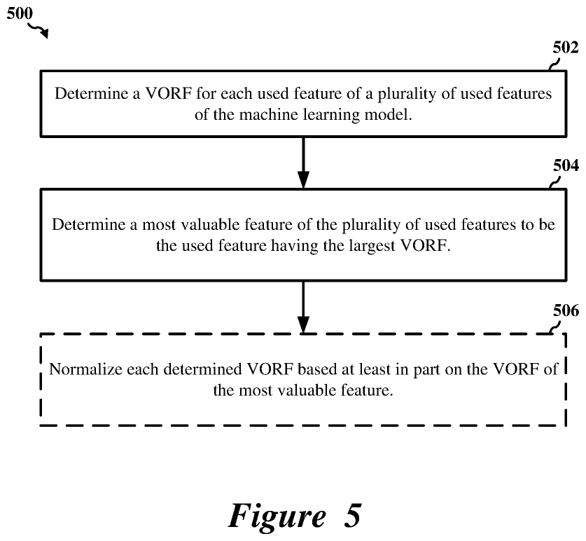

FIG. 5 shows an illustrative flow chart depicting an example operation 500 for determining a most valuable feature used by a machine learning model, according to some implementations. The example operation 500 can be performed by one or more processors of a system. For example, the system can include or can be associated with the feature value determination system 100 of FIG. 1. It is to be understood that the example operation 500 can be performed by any suitable systems, computers, or servers. At block 502, the feature value determination system 100 determines a VORF for each used feature of a plurality of used features of the machine learning model. For example, determining each VORF in block 502 may including performing one or more of operations 300 and 400 of FIGS. 3 and 4. At block 504, the feature value determination system 100 determines a most valuable feature of the plurality of used features to be the used feature having the largest VORF. Optionally, at block 506, the feature value determination system 100 normalizes each determined VORF based at least in part on the VORF of the most valuable feature.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for determining a value over replacement feature (VORF) for one or more features of a machine learning model, the method comprising:
selecting one or more features used in the machine learning model;
determining a comparison set of unused features not used in the machine learning model;
for each unused feature in the comparison set, determining a difference in a specified metric when the selected one or more features are replaced by a corresponding unused feature from the comparison set; and
determining the VORF to be the smallest difference in the specified metric.

2. The method of claim 1, wherein the specified metric comprises an accuracy metric.

3. The method of claim 1, wherein the specified metric is a metric of model accuracy per unit cost.

4. The method of claim 1, wherein the comparison set comprises a set of all features available for use but not currently used by the machine learning model.

5. The method of claim 1, wherein the comparison set comprises a subset of features available for use but not currently used by the machine learning model.

6. The method of claim 5, wherein the subset is a randomly selected subset.

7. The method of claim 1, wherein, for each unused feature in the comparison set, determining the difference in the specified metric comprises:
determining a first value of the specified metric for the machine learning model including the selected one or more features;
retraining the machine learning model with the selected one or more features replaced by a corresponding unused feature in the comparison set;
determining a second value of the specified metric for the retrained machine learning model; and
determining the difference in the specified metric to be a difference between the first value of the specified metric and the second value of the specified metric.

8. The method of claim 1, further comprising:
determining a VORF for each used feature of a plurality of used features of the machine learning model; and
determining a most valuable feature of the plurality of used features to be the used feature having the largest VORF.

9. The method of claim 8, wherein determining the VORF for each used feature of the plurality of used features comprises normalizing each determined VORF based at least in part on the VORF of the most valuable feature.

10. An apparatus coupled to a machine learning model, the apparatus comprising:
one or more processors; and
a memory storing instructions, wherein execution of the instructions by the one or more processors, causes the apparatus to perform operations comprising:
selecting one or more features used in the machine learning model;
determining a comparison set of unused features not used in the machine learning model;
for each unused feature in the comparison set, determining a difference in a specified metric when the selected one or more features are replaced by a corresponding unused feature from the comparison set; and
determining a value over replacement feature (VORF) to be the smallest difference in the specified metric.

11. The apparatus of claim 10, wherein the specified metric comprises an accuracy metric.

12. The apparatus of claim 10, wherein the specified metric comprises a metric of model accuracy per unit cost.

13. The apparatus of claim 10, wherein the comparison set comprises a set of all features available for use but not currently used by the machine learning model.

14. The apparatus of claim 10, wherein the comparison set comprises a subset of features available for use but not currently used by the machine learning model.

15. The apparatus of claim 14, wherein the subset is a randomly selected subset.

16. The apparatus of claim 10, wherein execution of the instructions for determining the difference in the specified metric causes the apparatus to perform operations further comprising, for each unused feature in the comparison set:
determining a first value of the specified metric for the machine learning model including the selected one or more features;
retraining the machine learning model with the selected one or more features replaced by a corresponding unused feature in the comparison set;
determining a second value of the specified metric for the retrained machine learning model; and
determining the difference in the specified metric to be a difference between the first value of the specified metric and the second value of the specified metric.

17. The apparatus of claim 10, wherein execution of the instructions causes the apparatus to perform operations further comprising:
determining a VORF for each used feature of a plurality of used features of the machine learning model; and
determining a most valuable feature of the plurality of used features to be the used feature having the largest VORF.

18. The apparatus of claim 17, wherein execution of the instructions for determining the VORF for each used feature of the plurality of used features causes the apparatus to perform operations further comprising normalizing each determined VORF based at least in part on the VORF of the most valuable feature.

19. A non-transitory computer-readable storage medium storing instructions which, when executed by one or more processors of an apparatus coupled to a machine learning model, cause the apparatus to perform operations comprising:
selecting one or more features used in the machine learning model;
determining a comparison set of unused features not used in the machine learning model;
for each unused feature in the comparison set, determining a difference in a specified metric when the selected one or more features are replaced by a corresponding unused feature from the comparison set; and
determining a value over replacement feature (VORF) to be the smallest difference in the specified metric.

20. The non-transitory computer-readable storage medium of claim 19, wherein execution of the instructions for determining the difference in the specified metric further causes the apparatus to perform operations comprising:
determining a first value of the specified metric for the machine learning model including the selected one or more features;
retraining the machine learning model with the selected one or more features replaced by a corresponding unused feature in the comparison set;
determining a second value of the specified metric for the retrained machine learning model; and
determining the difference in the specified metric to be a difference between the first value of the specified metric and the second value of the specified metric.
